(19) United States
(12) Patent Application Publication
(10) Pub. No.: US 2008/0190570 A1
(43) Pub. Date: Aug. 14, 2008

(54) End Stop Device for Blind-Rolling Shafts

(76) Inventor: Francisco Guillen Chico, Sax (ES)

Correspondence Address: TROP PRUNER & HU, PC, 1616 S. VOSS ROAD, SUITE 750, HOUSTON, TX, 77057-2631, US

(21) Appl. No.: 11/886,199

(22) PCT Filed: Mar. 21, 2005
(86) PCT No.: PCT/ES05/70030

§ 371 Date: Mar. 6, 2008

(51) Int. Cl. E06B 9/76; E06B 9/88

(52) U.S. Cl. 160/305

(57) ABSTRACT

The object of the present invention is an end stop device for blind-rolling shafts that can be used for a wide range of blinds regardless of their length, as well as having a high breaking strength as a helical cylindrical pinion must only engage an endless gear, so that its lifetime measured in number of cycles resisting fatigue is very high, as well as having a special construction of the helical cylindrical pinion formed by two parts, as well as of the assembly meant to determine the end of run, which has a counter for the number of turns made by the blinds shaft.

### OBJECT OF THE INVENTION

The object of the present invention is an end stop device for blind-rolling shafts that can be used in a wide range of blinds, regardless of their length.

In addition, it has a high breaking strength as it must engage a helical cylindrical pinion only with an endless gear, so that its lifetime measured in number of cycles with resistance to fatigue is very high.

This winding mechanism is also characterised by a special constitution of the helical cylindrical pinion, formed by two parts, as well as the assembly meant to determine the end of run, which also presents a counter for the number of revolutions of the blinds shaft.

### BACKGROUND OF THE INVENTION

Mechanisms and devices are well known in the state of the art for stopping the blinds at their position of maximum winding, which consist of an endless gear, a central pinion and one or two satellite pinions about the aforementioned pinion.

Within systems with one satellite pinion is document ES2130875, in which the central and the satellite pinion have corresponding inserts which meet laterally to lock the system in one sense of rotation, so that it can only rotate in the opposite sense.

In said systems at least two pairs of contacts are established between the teeth of the endless gear and the pinions, the central pinion simultaneously contacting the endless gear and the satellite pinion, so that their teeth are subjected to greater loads a greater number of time, leading to breakage of the mechanisms due to fatigue of the teeth of said central pinion.

In addition, the path of the blinds handle is limited by the size and the number of teeth of both the central pinion and the satellite pinion.

The size of the pinions is determined by the space limitations, so that the only variable is the number of teeth which, for a given pinion size, depends on the loads it must withstand.

In this way, the height of the blinds cannot exceed a certain length, as otherwise the stop will be reached before the blinds are fully raised.

All of these drawbacks are overcome by the invention described below.

### DESCRIPTION OF THE INVENTION

The present invention relates to an end stop device for blind-rolling shafts formed by a case which in turn consists of two essentially identical half-bodies provided with internal recesses and protrusions where the device elements are housed.

Among the device elements is the endless gear, which is driven from the outside by a handle, a cardan shaft or whichever drive means is available.

When the endless gear turns is actuates the helical cylindrical pinion, which rests on a circumferential seat of a coupling flange in which is inserted the blinds shaft, to which the pinion transmits its motion.

Placed outside the coupling flange and above the helical cylindrical pinion is a circular ring with a convex protrusion that together with another protrusion antagonistic of a toothed wheel will determine the end of run.

One of the case half-bodies is provided with a protrusion in the form of a circular crown, inside which a stud is inserted that crosses a housing body which is coupled to the external circumference of the circular crown-shaped protrusion.

The lower part of the housing body has tabs which are guided to close an upper part of said housing body.

The upper part of the housing body has an orifice that houses a ball and a spring, the ball having a diameter “d” slightly smaller than the diameter “D” of the orifice, so that it can pass through all its sections except through the upper section of the orifice, which has a diameter “D′”, where the diameters have the following relationship:

D′<d<D.

In this way, the spring compressed by the closing action of the bottom part of the housing body will push the ball against the end of the orifice, so that the ball juts out of the top of the housing body.

The portion of the ball that juts out will never be more than its radius, i.e. “d/2”, due to the section of the orifice with a diameter of “D′” smaller than the diameter of the ball, “d”, which acts as a stop.

Located above the housing body is the toothed wheel with pointed teeth, having a concave inter-tooth space with the exception of an area between two consecutive teeth, which is convex from the end of one tooth to the other and which is responsible for determining the end of run when it meets the convex protrusion of the circular ring placed above the helical cylindrical pinion.

The toothed wheel is provided on its lower part with a number of adjacent essentially hemispheric cut-outs, in a number identical to that of the teeth of the toothed wheel, these cut-outs located about a circumference of a certain radius.

These essentially hemispheric cut-outs allow housing the ball of the housing body when the toothed wheel revolves.

As the helical cylindrical pinion turns, it carries with it the circular ring with a convex protrusion so that when it is opposite the toothed wheel it will engage said wheel and make it turn by an amount determined by the number of teeth, so that the housing body ball will enter the next cut-out.

The convex protrusion of the circular ring will rotate another turn until it is opposite and engages another tooth of the toothed wheel.

The end of run will occur when the convex protrusion of the circular ring meets the convex area of the toothed wheel.

To ensure the invariability of the relative distance between the blinds shaft and the shaft of the toothed wheel, above the circular ring and the toothed wheel is placed a plate with two orifices that can be coupled to the outer shape of the coupling flange and the stud.

Lastly, it is necessary to known the gear ratios between each of the two gear pairs and the diameter of the blinds shaft; to know the essentially hemispherical cut-out that must be placed on the ball in the initial position, as well as the initial position of the helical cylindrical pinion that defines that of the circular ring and its convex protrusion, all of this according to the height of the blinds so that the end of run occurs when the blinds are in a fully raised position.

This construction provides a system that can be used for a wide range of blinds with very different lengths, while lengthening the lifetime cycles of the mechanism.

### DESCRIPTION OF THE DRAWINGS

The present descriptive memory is completed by a set of drawings that illustrate the preferred and non-limiting example of the invention.

FIG. 1 shows an exploded perspective view of the end of run for winding shafts of blinds.

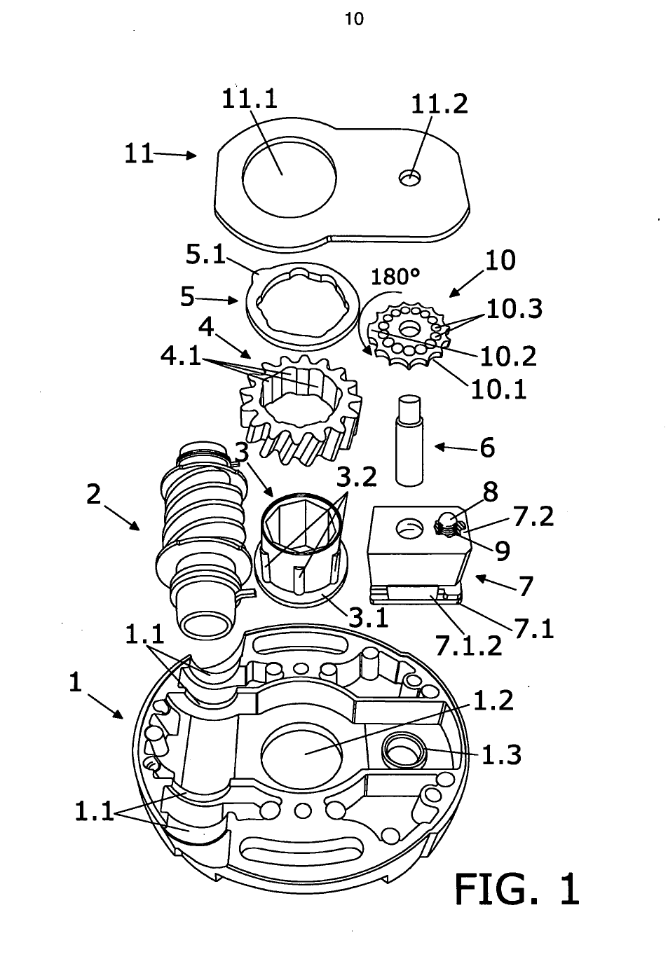

### PREFERRED EMBODIMENT OF THE INVENTION

In view of the above, the present invention relates to an end stop device for blind-rolling shafts formed by a case that in turn consists of two essentially identical half-bodies (1) provided with recesses and internal protrusions in which the elements of the device are housed.

Each half-body (1) has a number of arc-shaped seats (1.1) meant to house the endless gear (2), as well as a central orifice (1.2) for housing the winding shaft of the blinds.

Above said central orifice (1.2) is placed a circumferential seat (3.1) of a coupling flange (3) of the shaft which has a number or ribs (3.2) to ensure the correct positioning of the grooves (4.1) of a helical cylindrical pinion (4).

This constitutes the engagement between the endless gear (2) and the helical cylindrical pinion (4), transmitting the motion of the actuation handle to the winding shaft of the blinds.

Outside the coupling flange and above the helical cylindrical pinion (4) is placed a circular ring (5) with a convex protrusion (5.1).

One of the case half-bodies (1) has a circular crown-shaped protrusion (1.3) inside which is inserted a stud (6) that crosses a housing body (7) that is coupled to the external circumference of the circular crown-shaped protrusion (1.3).

The housing body (7) is formed by a lower part (7.1) provided with tabs (7.1.2) which are guided to close against an upper part (7.2) of said housing body (7).

In turn, the upper part (7.2) of the housing body (7) has an orifice (7.3) which houses a rigid element (8), preferably a ball, and an elastic element (9), preferably a spring, wherein the elastic element (9) pushes the rigid element (8), which can pass through all the sections of the orifice (7.3) save the top one, so that the rigid element (8) juts out of the upper part (7.2) of the housing body (7).

Above the housing body (7) is a toothed wheel (10) having the stud (6) as its shaft, with pointed teeth and a concave inter-tooth space (10.1) antagonistic of the convex protrusion (5.1) of the circular ring (5).

One area (10.2) between two consecutive teeth is convex, covering the space from one end of a tooth to another, determining the end of run when it meets the convex protrusion (5.1) of the circular ring (5).

The toothed wheel (10) is provided on its bottom part with a number of adjacent cut-outs (10.3), preferably hemispherical, identical in number to the teeth of said toothed wheel (10). These cut-outs (10.3) are arranged about a circumference with a fixed radius in order to house the rigid element (8) of the housing body (7) when the toothed wheel (10) turns.

To ensure the invariability of the relative distance between the blinds shaft and the shaft of the toothed wheel (10), above the circular ring (5) and the toothed wheel (10) is placed a plate (11) with two orifices (11.1, 11.2) that can be coupled to the outer shape of the coupling flange (3) and the stud (6).

Knowing the gear ratios between each of the two gear pairs and the diameter of the blinds shaft allows determining the initial position of the toothed wheel (10) above the rigid element (8), as well as the initial position of the helical cylindrical pinion (4) that defines that of the convex protrusion (5.1) of the circular ring (5), all of this according to the height of the blinds so that the end of run occurs when the blinds are in a fully raised position.

The essence of this invention is not affected by variations in the materials, shape and size of its component elements, described in a non-limiting manner that will allow its reproduction by an expert.

1. End stop device for blind-rolling shafts among those having two half-bodies (1) provided with orifices for driving an endless gear (2) and for inserting the blinds shaft, wherein the spiral of the endless gear (2) engages the helical teeth of a central pinion, characterised in that the helical cylindrical pinion (4) rests on a circumferential seat (3.1) of a coupling shaft (3) internal to the helical cylindrical pinion (4), above which is placed a circular ring (5) with a protrusion (5.1) which when it meets an area (10.2) of a toothed wheel (10) will determine the end of the run, wherein the toothed wheel (10) has a stud (6) as its shaft and rests, by one of the contiguous cut-outs (10.3) provided on its rear part, on a rigid element (8) joined to a housing body (7) by an elastic element (9), so that the protrusion (5.1) of the circular ring (5) engages the inter-tooth space (10.1) of the toothed wheel (10) such that the contiguous cut-out (10.3) will rest on the rigid element (8).

2. End stop device for blind-rolling shafts according to claim 1, characterised in that the protrusion (5.1) of the circular ring (5) is has a convex shape.

3. End stop device for blind-rolling shafts according to claim 1, characterised in that the area (10.2) of the toothed wheel (10) that determines the end of run has a convex shape.

4. End stop device for blind-rolling shafts according to claim 1, characterised in that the inter-tooth area (10.3) of the toothed wheel (10) has a convex shape.

5. End stop device for blind-rolling shafts according to claim 1, characterised in that the housing body (7) is formed by a bottom part (7.1) provided with tabs (7.1.2) which are guided to close against an upper part (7.2) of said housing body (7).

6. End stop device for blind-rolling shafts according to claim 1, characterised in that the rigid element (8) is a ball.

7. End stop device for blind-rolling shafts according to claim 1, characterised in that the rigid element (8) is a cylinder.

8. End stop device for blind-rolling shafts according to claim 1, characterised in that the rigid element (8) is a cone.

9. End stop device for blind-rolling shafts according to claim 1, characterised in that the rigid element (8) is a truncated cone.

10. End stop device for blind-rolling shafts according to claim 1, characterised in that the elastic element (9) is a spring.
